(19) United States
(12) Patent Application Publication
(10) Pub. No.: US 2023/0419139 A1
(43) Pub. Date: Dec. 28, 2023

(54) DYNAMIC SCHEMA MAPPING BETWEEN MICROSERVICES

(71) Applicant: INTUIT INC., Mountain View, CA (US)

(72) Inventors: Ranadeep BHUYAN, Bangalore (IN); Piyush SHRIVASTAVA, Bangalore (IN); Vikram MANDYAM, Bangalore (IN); Narsimha Raju CHIGULLAPALLY, Bangalore (IN)

(73) Assignee: INTUIT INC., Mountain View, CA (US)

(21) Appl. No.: 17/809,518

(22) Filed: Jun. 28, 2022

(51) Int. Cl. G06N 7/00; G06F 16/21; G06N 20/00; H04L 67/51

(52) U.S. Cl. CPC G06N 7/005; G06F 16/211; G06N 20/00; H04L 67/51

(57) ABSTRACT

Disclosed dynamic schema mapping systems and methods monitor network traffic between different microservices and train mapping models based on the monitored network traffic using unsupervised training. This training of the mapping models generates a probability distribution tensor that shows the probabilistic associations of different key-value pairs of the schemas of different microservices. The trained mapping models are used to map a schema from a source microservice to another schema at a destination microservice. Should the translated schema be incompatible with the destination microservice, a semi-supervised approach is taken to make the translated schema compatible. The trained models may be reinforced (e.g., the probability distribution tensor may be updated) as more network traffic is collected and analyzed. The dynamic mapping therefore allows a system to be schema-agnostic, and developers may be able to define application interfaces or interaction schemas without the necessity of accounting for compatibility constraint between the different schemas.

### BACKGROUND

A backend of a system infrastructure typically deploys a plurality of microservices. Microservices provide different types of functionalities within the system infrastructure. For instance, a first microservice may generate an intake user interface to prompt user data entry, a second microservice may generate a presentation user interface to display the processed user data, a third microservice may handle the processing of the entered user data to generate the displayed user data, etc. Other microservices may store the data and allow access thereto. Microservices therefore generally allow segmented, granular level of functionalities within the larger system infrastructure. Microservices communicate through synchronous and asynchronous interfaces. For instance, a communication interface for microservices may include a message to a message queue and or a message reply to message queue.

Different microservices, however, use different schemas. Schemas, also referred to as metadata models, are generally the data format used by the microservices to store, transmit, and or receive data. The data format typically includes a cluster of fields, types of the fields (e.g., string, number, etc.), size of the fields, and the like. The schemas are generally different because the microservices may be developed by different software teams at different points in time to solve different sets of problems. For instance, each microservice may have a tailored schema based on the design requirements, resource constraints, developer preferences, etc. associated with that particular microservice. These tailored schemas may not match because, e.g., the data fields may have a different organization or different field names, among other things, thereby reducing the inter-compatibility between the microservices.

Conventional techniques of handling the difference between schemas are manual, cumbersome, and inefficient. For instance, application programming interface (API) standardization has been used to handle the differences. This standardization, however, includes a manual lookup of the microservices' schemas followed by a manual construction of the API calls between the microservices to account for the differences. In addition to the cumbersome nature of this manual process, the constructed API calls remain rigid and therefore inefficient—these calls will only address the manually discerned differences between the known microservices. There is no automatic generalization to incorporate additional and newer microservices.

As such, a significant improvement on the inter-compatibility between different microservices is therefore desired.

### SUMMARY

Embodiments disclosed herein solve the aforementioned technical problems and may provide other technical solutions as well. The disclosed dynamic schema mapping systems and methods monitor network traffic between different microservices and train mapping models based on the monitored network traffic using unsupervised training. This training of the mapping models generates a probability distribution tensor to show probabilistic associations of different key-value pairs of the schemas of different microservices. The trained mapping models may be used to map (or translate) a schema from a source microservice to another schema at a destination microservice. Should the translated schema be incompatible with the destination microservice, a semi-supervised approach is taken to make the translated schema compatible. The trained models may be reinforced (e.g., the probability distribution tensor may be updated) as more network traffic is collected and analyzed. The dynamic mapping therefore allows a system to be schema-agnostic, and developers are able to define schemas without the necessity of accounting for compatibility constraints between the different schemas.

### BRIEF DESCRIPTION OF THE DRAWINGS

FIG. 1 shows an example of a system configured for dynamic schema mapping between microservices, based on the principles disclosed herein.

FIG. 2 shows an example architecture for dynamic schema mapping, based on the principles disclosed herein.

FIG. 3 shows details of a portion of the example architecture shown in FIG. 2, based on the principles disclosed herein.

FIG. 4 shows a flow diagram of an example method of generating a schema mapping between different microservices, based on the principles disclosed herein.

FIG. 5 shows an example of a probability distribution tensor generated during the execution of the method shown in FIG. 4, based on the principles disclosed herein.

FIGS. 6A-6C show example schema mapping between two microservices, based on the principles disclosed herein.

FIG. 7 shows a flow diagram of an example method of translating schemas between different microservices, based on the principles disclosed herein.

FIG. 8 shows a block diagram of an example computing device that implements various features and processes, based on the principles disclosed herein.

### DETAILED DESCRIPTION OF SEVERAL EMBODIMENTS

Use of different schemas between different microservices provides a huge technical challenge in a system infrastructure. Because the microservices have to communicate with each other to collaboratively realize several functionalities provided by the system, the schemas have to be translated. The conventional solution has been to perform a manual translation, which is cumbersome, time consuming, and static. Furthermore, a microservice developer has an additional constraint when developing a microservice, he or she will have to be concerned about the compatibility of the microservice with other microservices within the system infrastructure.

Embodiments disclosed herein are directed to solving these technical challenges and also to providing a schema-agnostic development of microservices. The embodiments train—during runtime—mapping models from the network traffic data, where the mapping models probabilistically map the different schemas. For example, a field of one schema may be probabilistically mapped to another field of another schema, even when the names, sizes, and or other attributes of the two fields are different. Different training algorithms may be used to generate the models. An example training model comprises a naïve Bayes algorithm. The training models may generate a probability distribution tensor, which expresses the probabilistic relationship between different key-value pairs (e.g., generated by the naïve Bayes model) between the different schemas.

In one or more embodiments, the initial training is unsupervised. The models attempt to generate generalized classes from specific instances, e.g., using predictive probability such as naïve Bayes algorithms. For example, specific instances of “consumer price,” “customer price,” “market price,” “sale price,” etc. may be mapped into a generalized class of “retail price.” The key-value pairs generated by the generalized classification may therefore be, in the key (general class)-value (specific instance of the generalized class) format: retail price-consumer price, retail price-customer price, retail price-market price, retail price-sale price, etc. This generalization is used to map the specific instances. For example, consumer price in a first schema may be mapped to retail price; customer price in a second schema may also be mapped to the retail price; and because each of the instances are mapped to the same class, the instances can be mapped to each other, thereby matching the consumer price to customer price. The probabilistic relationships between the different key-value pairs generated at multiple points in the network are represented by the probability distribution tensor.

The initial training, however, may not provide a desired level of accuracy. A semi-supervised approach may then be used to increase accuracy. For example, one or more trained models (using the probability distribution tensor) will translate a first schema of a first microservice to a second schema of a second microservice. The second schema (translated from the first schema) is sent to the second microservice. If the second microservice generates an error message (e.g., indicating an incompatible schema), the second schema may be manually evaluated and or another machine learning model may be trained based on the error. When the error is corrected, the trained mapping models and the probability distribution tensor are updated to account for the error correction. As more network traffic data is collected and as more translations are performed, the trained mapping models are progressively reinforced. In some embodiments, the reinforcements are performed until a desired level of translation accuracy is reached.

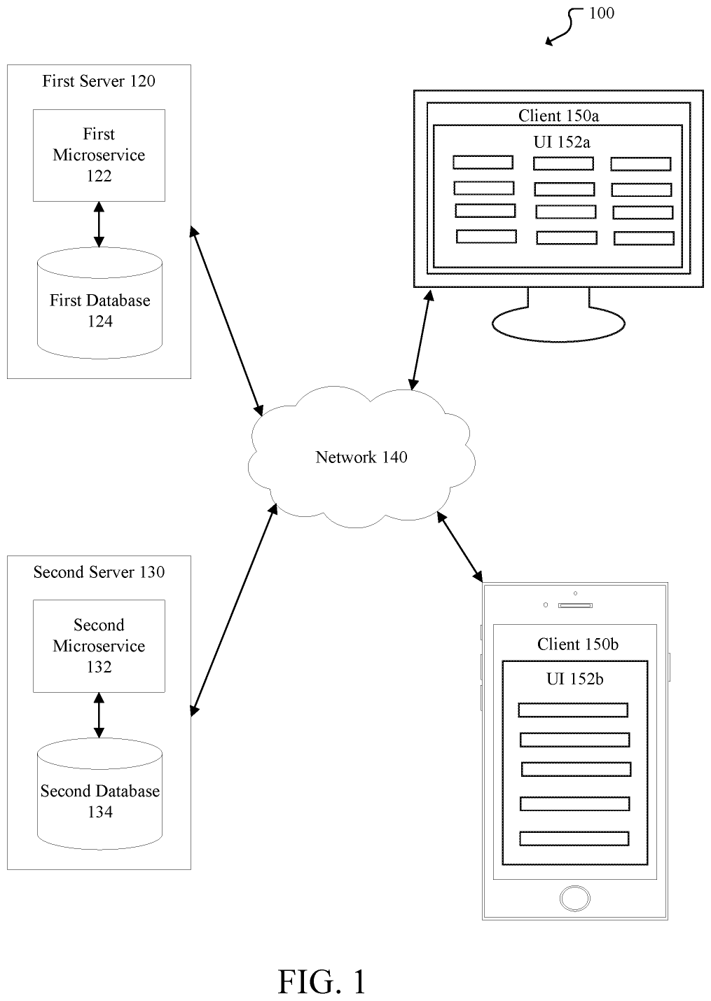

FIG. 1 shows an example of a system 100 configured for dynamic schema mapping between microservices, based on the principles disclosed herein. It should be understood that the components of the system 100 shown in FIG. 1 and described herein are merely examples and systems with additional, alternative, or fewer number of components should be considered within the scope of this disclosure.

As shown, the system 100 comprises client devices 150a, 150b and servers 120, 130 interconnected through a network 130. A first server 120 hosts a first microservice 122 and a first database 124 and a second server 130 hosts a second microservice 132 and a second database 134. The client devices 150a, 150b have user interfaces 152a, 152b, which may be used to communicate with the microservices 122, 132 using the network 140. For example, communication between the elements is facilitated by one or more application programming interfaces (APIs). APIs of system 100 may be proprietary and or may include such APIs as Amazon® Web Services (AWS) APIs or the like. The network 140 may be the Internet and or other public or private networks or combinations thereof. The network 140 therefore should be understood to include any type of circuit switching network, packet switching network, or a combination thereof. Non-limiting examples of the network 140 may include a local area network (LAN), metropolitan area network (MAN), wide area network (WAN), and the like.

Client devices 150 include any device configured to present user interfaces (UIs) 152 and receive user inputs 154. The UIs 152 are configured to display responses 156 to the user inputs 154. The responses 156 include, for example, personalized answers, call queue confirmation, contact information of an appropriate subject matter expert, and or other outputs generated by the first server 120. The UIs 152 also capture session data including UI screen identifiers (id), product id (e.g., product SKU), input text/product language, geography, platform type (e.g., online vs. mobile), and or other context features. Exemplary client devices 150 include a smartphone, personal computer, tablet, laptop computer, and or other device.

In some embodiments, the first microservice 122 and or second microservice 132 implements an information service, which is any network 140 accessible service that maintains financial data, medical data, personal identification data, and or other data types. For example, the information service may include QuickBooks® and its variants by Intuit® of Mountain View, California. The information service provides one or more features that use the structured form representations and structured metadata generated by the system 100. It should however be understood that the two microservices 122, 132 are just for illustration; and the system 100 may include a large number of microservices.

The microservices 122, 132 may, however, use different schemas. For example, the first microservice 122 may have been developed to solve a particular type of problem using a particular type of data and the second microservice 122 may have developed to solve another type of problem with another type of data. The schemas therefore may have different fields, different field names for the same information, different lengths of the fields, etc. For example, the first UI 152a may be associated with the first microservice 122 and the second UI 152b may be associated with the second microservice 132. The data captured using the first UI 152a may therefore be incompatible with the second microservice 132 and the data captured using the second UI 152b may be incompatible with the first microservice 122. Therefore, in accordance with the disclosed principles, a translation between the schemas is supported by the system 100.

First server 120, second server 130, first database 124, second database 134, and client devices 150 are each depicted as single devices for ease of illustration, but those of ordinary skill in the art will appreciate that first server 120, second server 130, first database 124, second database 134, and or client devices 150 may be embodied in different forms for different implementations. For example, any or each of first server 120 and second server 130 may include a plurality of servers or one or more of the first database 124 and second database 134. Alternatively, the operations performed by any or each of first server 120 and second server 130 may be performed on fewer (e.g., one or two) servers. In another example, a plurality of client devices 150 may communicate with first server 120 and/or second server 130. A single user may have multiple client devices 150, and/or there may be multiple users each having their own client devices 150.

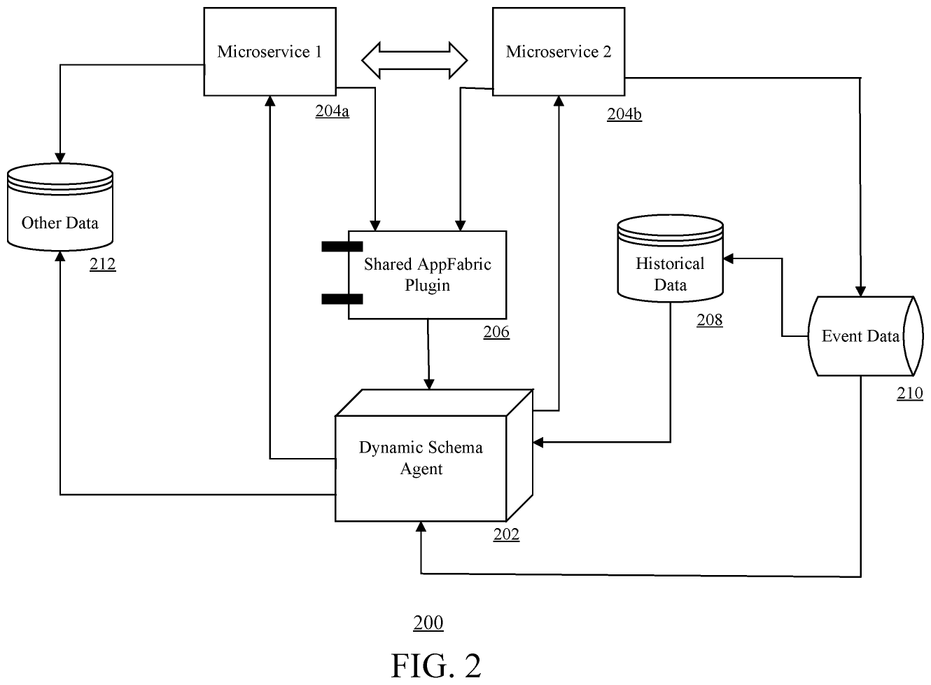

FIG. 2 shows an example architecture 200 for dynamic schema mapping, based on the principles disclosed herein. The example architecture 200 may be implemented by any combination of the components of the system 100 shown in FIG. 1. It should be understood that the architecture 200 and its constituent components are just for illustration and should not be considered limiting. Architectures with additional, alternative, and fewer number of components should also be considered within the scope of this disclosure. Within the architecture 200, a dynamic schema agent 202 generates a mapping between a first microservice 204a and a second microservice 204b based on collected and analyzed network traffic data.

In the illustrated embodiment, the first microservice 204a uses a first data schema and the second microservice 204b uses a second data schema. In an example embodiment in which the microservices 204a, 204b are for used recordkeeping, the first microservice 204a uses a first set of data fields and associated attributes (e.g., length of entry for a particular data field) and the second microservice 204b uses a second set of data fields and associated attributes. As a non-limiting example, Table 1 shows a subset of various data fields for the first microservice:

TABLE 1
Subset of data fields of the first microservice.

Type
Name
Image
SKU
Category
Qty on Hand
Reorder Point
Qty on PO
Inventory Asset a/c
Description
Sales price
Income a/c
Purchasing Info
Cost
Expense a/c
Preferred Vendor
Taxable

Table 2 shows a subset of data fields of the example second microservice:

TABLE 2
Subset of data fields of the second microservice

Product without stock
levels
Picture
Identifier
Supplier Code
Purchase cost
On hand
Stock Keeping Unit
ProductType
Cost of Goods a/c
Available Stock
Minimum Order Quantity
Variant Description
Retail Price
Default Sales Account
Asset a/c
Customs Descriptions
This item is taxable

In the illustrated embodiment, the microservices 204a, 204b use different data schemas with different fields to store, retrieve, and process the same type of data records. The dynamic schema agent 202 automatically maps the different schemas such that the operations between the microservices 204a, 204b are compatible.

The dynamic schema agent 202 performs the mapping based on the data—associated with communication and processing by the microservices 204a, 204b—from several different sources. For example, the dynamic schema agent 202 may interrogate (e.g., request a piece of data) each microservice 204a, 204b. In one or more embodiments, a shared application fabric plugin 206 is provided to the microservices 204a, 204b, where the plugin 206 listens to the communication between the microservices 204a, 204b. The dynamic schema agent 202 gathers data from an event database 210 and or historical database 208 (e.g., the historical database 208 may receive the event data in the event database 210 in batches such as daily batches, weekly batches, etc.). Additionally, the dynamic schema agent 202 may gather data from another database 212, which should be understood to be any kind of database used by one or more of the microservices 204a, 204b.

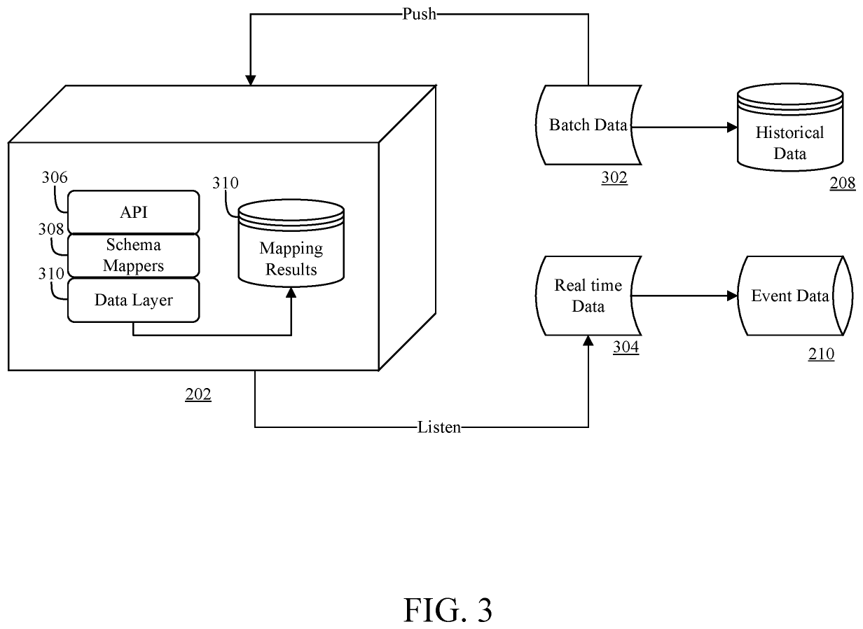

FIG. 3 shows details of a portion of the example architecture 200 shown in FIG. 2, based on the principles disclosed herein. In particular, the components of the dynamic schema agent 202 are shown. As shown, the dynamic schema agent 202 receives batch data 302 from the historical database 208 and listens to the real-time data 304 of the event database 210. Based on training models using the batch data 302 and or the real-time data 304, the dynamic schema agent 202 generates and or updates schema mappers 308. In other words, the schema mappers 308 include mapping models and or a probability distribution tensor, which are used for mapping and translating between several different schemas.

In addition to the schema mappers 308, the illustrated dynamic schema agent 202 includes an application programming interface (API) 306 to interact with other components within the architecture 200, such as the historical database 208 and the event database 210. In some embodiments, the API 306 may be a REST API. The illustrated dynamic schema agent 202 also includes a data layer 310 that interfaces the schema mappers 208 with a mapping results database 310. For example, the mapping results database 310 includes a probability distribution tensor that is used by the schema mappers 310. The data layers 310 allow the schema mappers 308 to access and or update the probability distribution tensor in the mapping results database 310.

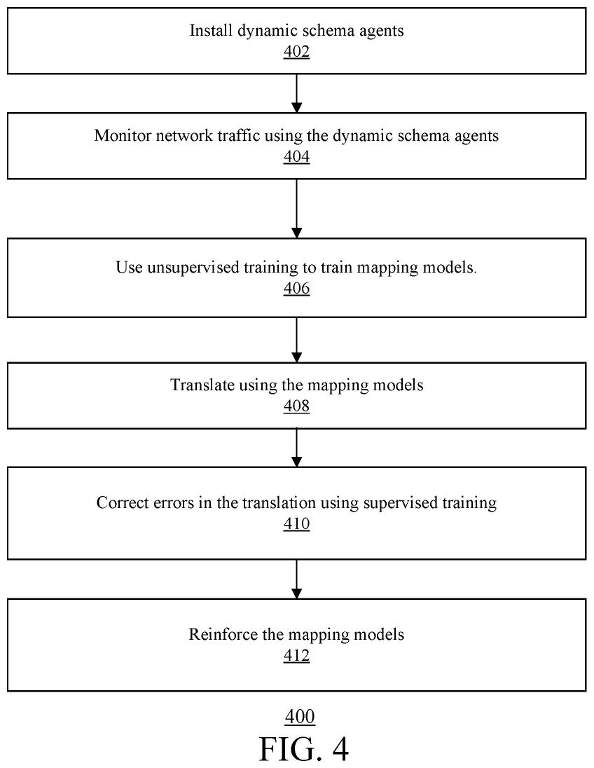

FIG. 4 shows a flow diagram of an example method 400 of generating a schema mapping between different microservices, based on the principles disclosed herein. The schema mapping may be organized into a library and or a database (e.g., mapping results database 310), which may be accessed when different schemas have to be converted. It should be understood that method 400 shown in FIG. 4 and described herein is just an example, and methods with additional, alternative, and fewer number of steps should be considered within the scope of this disclosure. The steps of the method 400 may be performed by one or more components of the system 100 shown in FIG. 1 and or one or more components of the architecture 200 shown in FIGS. 2-3.

The method 400 begins at step 402 where dynamic schema agents (an example dynamic schema agent 202 is shown in FIGS. 2-3) are installed. The dynamic schema agents may be installed at different points in a network. For example, the dynamic schema agents may be installed as plugins to different network nodes, e.g., microservices and or communications link in between. The installation of the dynamic schema agents at different points in the network is an example—and any kind of software and or hardware deployment to monitor network traffic between different microservices to map the schemas should be considered within the scope of this disclosure.

At step 404, the dynamic schema agents are used to monitor network traffic. The network traffic may include communications, e.g., API calls, data exchange, etc., between the different microservices. The monitoring includes tracking the different source and destination microservices, e.g., a source and destination interceptor within the dynamic schema agent extracts the information on the source microservice and the destination microservice to determine where the communication is coming from and where it is going to.

At step 406, an unsupervised training technique is used to train mapping models. The mapping models include machine learning models (e.g., within the schema mappers 308 shown in FIG. 3), and the training utilizes the monitored traffic to train the machine learning models. It should be understood that step 406 can occur at any point in time for generating and or retraining the mapping models. For example, step 406 may be used for initial training using a threshold amount of initially gathered data. The initial training may generate initial models, which may then be further trained and reinforced as more and more network traffic data is monitored and gathered. In other example, the step 406 is used for retraining and or further training of a model already trained (e.g., through a previous iteration of the method 400). The retraining may be used, for example, when a desired threshold accuracy changes, i.e., a prediction with a higher amount of accuracy is desired, and the retraining with additional data improves the prediction accuracy.

The training at step 406 may involve any kind of machine learning and or statistical model. The training generally determines different patterns within the different schemas to map different fields between the schemas such that the schemas become translatable and compatible. For instance, a first cluster of fields with different numbers and attributes in a first schema is translated using one or more trained mapping models to a second cluster of fields with other different numbers and attributes.

In some embodiments, the mapping models are naïve Bayesian models. The general principle of naïve Bayesian models is to determine classes for different instances. For example, a “customer price” field in a first schema and a “consumer price” in a second schema could be classified into the same class “retail price.” This classification is then used to map the specific instances. For instance, using the “retail price” classification (or generalization), the “customer price” field may be mapped to the “consumer price” field. The classification may be represented as key (i.e., class)-value (i.e., specific instance) pair: the key-value pairs for this example are retail price-customer price and retail price-consumer price.

To train the naïve Bayesian models (and or any other types of models), information from the network traffic is extracted. The extraction may use any kind of extraction methodology. For example, the text identifying the data (e.g., data field, data value) may be extracted from the network traffic. As another example, if the data traffic includes graphics to be rendered in a user interface (UI), image processing may be used to identify the text and extract the data therefrom. Any kind of extraction technique that extracts the data from the network traffic should be considered within the scope of this disclosure.

As described above, the training may be unsupervised. The naïve Bayes training algorithm (and or any other type of training algorithm) may determine the pattern in the network traffic data. For example, the training algorithm determines classes based on the observed instances. Some non-limiting examples of the classes may include: size of data values, length of key-value pairs, number of children for a particular field, ratio of verbs to nouns, and the like. These generalized classes are used for mapping: a field belonging to a class from a first schema may map to another field belonging to the same class from the second schema.

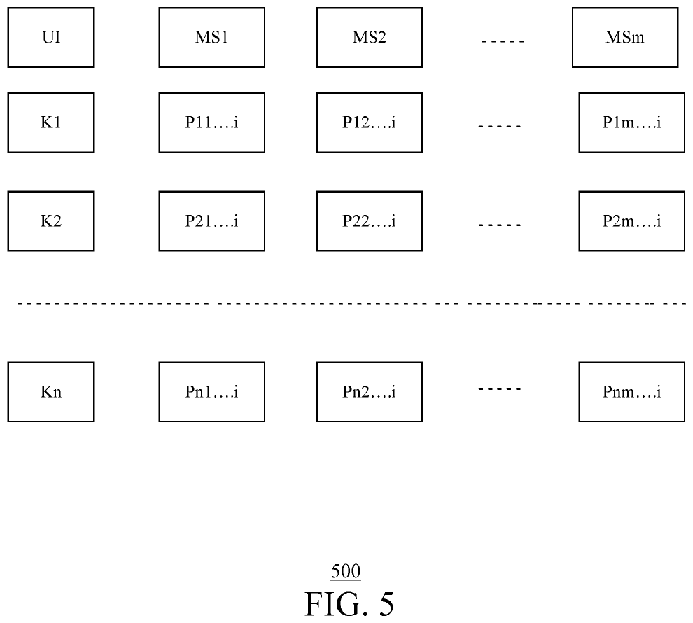

The network traffic data is monitored at multiple locations for multiple microservices thereby generating multiple key value pairs. Therefore, a three-dimensional probability distribution tensor (see FIG. 5) may be generated based on the training.

At step 408, schemas between the microservices may be translated using the mapping models (e.g., by using the probability distribution tensor shown in FIG. 5) At step 410, errors in the translation are corrected using supervised training. For example, a first schema is translated into a second schema using the probability distribution tensor 500. The second schema is sent to a receiving microservice. If the second microservice generates an error upon receipt of the second schema, an error condition is flagged, requiring human intervention to correct the error condition.

At step 412, the mapping models are reinforced using the error correction of step 410 and or the continuous collection of the network traffic data. For instance, there may be a desired level of accuracy for the mapping models and or the probability distribution tensor 500. The models may be retrained and reinforced until the desired level of accuracy is reached as reflected in the probability distribution tensor.

In some embodiments, the error corrections (e.g., of the translations between the schemas) include manual involvement and or training of additional error correction machine learning models. For example, the error corrections may include a supervised training, where the labels for the errors are hand-crafted and the error correction machine learning models are trained using the hand-crafted labels. The mapping models may therefore be continuously trained and reinforcement as new network traffic data and or translation error are available.

FIG. 5 shows an example of a probability distribution tensor 500 generated during the execution of the method 400, based on the principles disclosed herein. Alternative representations should also be considered within the scope of this disclosure.

As shown, the probability distribution tensor 500 represents n key-value pairs (K1 . . . Kn) for m microservices (MS1 . . . MSm) at i instances. The dimensions of the probability distribution tensor 500 are therefore n*m*i. In operation, the network traffic data from the m microservices is monitored at i locations and for each location, the key-value matching is performed (e.g., using naïve Bayes models). Therefore, for each key-value for each microservice, there may be i probabilities. To take a specific example from the illustrated probability distribution tensor 500, the key-value pair K1 for microservices MS1 has i probabilities P11.

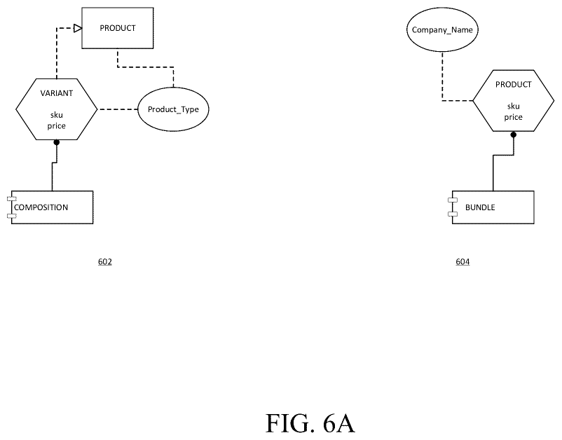

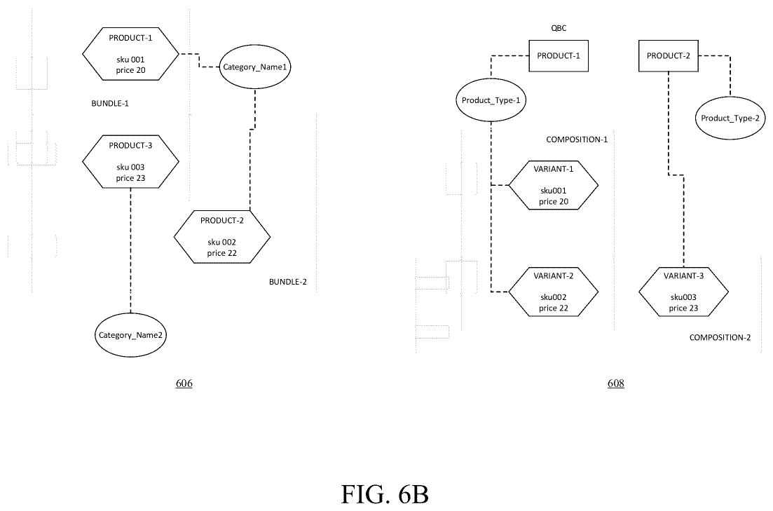

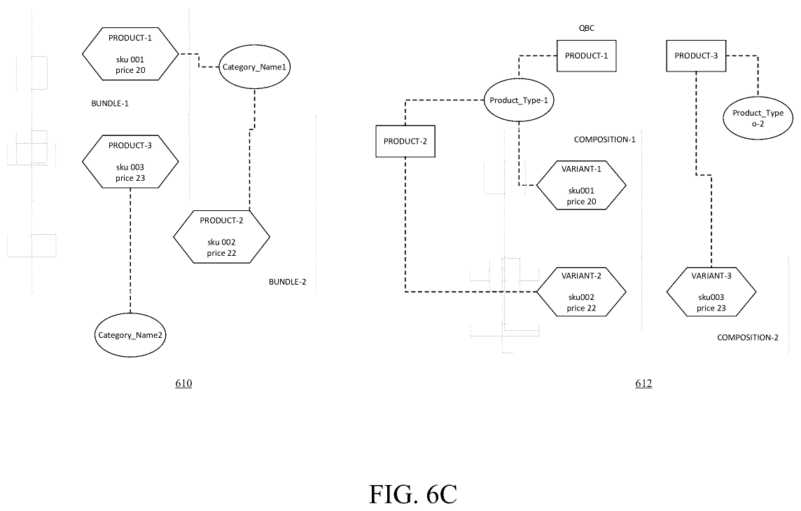

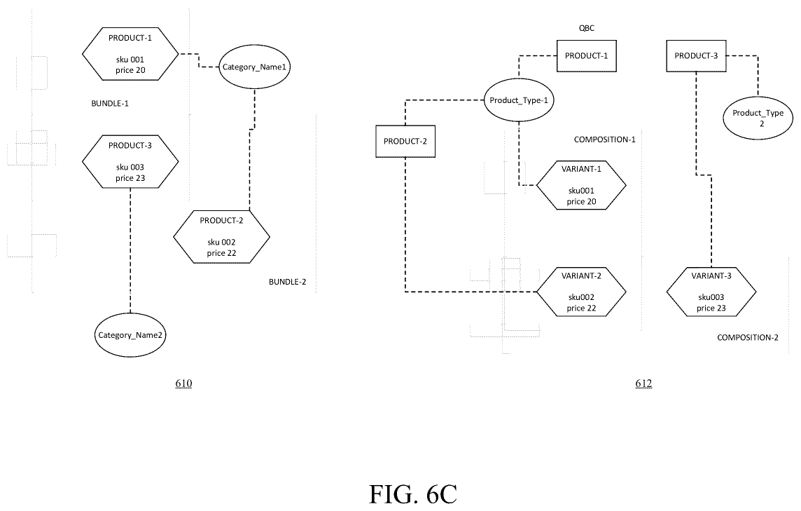

FIGS. 6A-6C show example mappings between two microservices, based on the principles disclosed herein. For example, FIG. 6A shows a first schema 602 of a first microservice and a second schema 604 of a second microservice. In the first schema 602, a “variant” field has two entries “sku” and “price.” In the second schema 604, the same entries “sku” and “price” are for a “product” field. In the first schema the “variant” field relates the “product” field. Therefore, there are two possibilities for the dynamic schema mapping, e.g., as executed by one or more mapping models and or the probability distribution tensor described above. The first possibility may be one product with multiple variants and the second possibility may be multiple products with one variant each.

FIG. 6B shows two mappings based on the first possibility of one product with multiple variants. For example, mapping 606 shows a composite of two instances of the second schema 604 (bundle-1 and bundle-2). In the mapping 606, product-1 and product-2 are variants of product category_name1 and product-3 may be variant of product category_name2. Therefore, product-1 from bundle-1 and product-2 from bundle-2 may therefore be mapped to a same generalized class category_name1. Furthermore, product-3, which is common to both bundle-1 and bundle-2, may be mapped to generalized class category_name2. Additional schemas may be added based on this mapping 606.

As another example, mapping 608 shows a composite of two instances of the first schema 602 (composition-1 and composition-2). In the mapping 608, variant-1 (in composition-1) and variant-2 (in both of the composition-1 and composition-2) may be mapped to the same product-1 of product_type_1. Furthermore, variant-3 (in composition-2) may be mapped onto product-2 of product_type_2. Therefore, the product (generalized class)-variant (specific instance) mapping therefore satisfies the first possibility of the one product with multiple variants. Based on this mapping, additional schemas may be added to the mapping 608.

FIG. 6C shows two mappings based on the second possibility with multiple products with one variant each. Mapping 610 shows a composite of two instances of the second schema 604 (bundle-1 and bundle-2). The mapping 610 may be same as the corresponding mapping 606 each of the product-1, product-2, and product-3 may be a product with a single variant. Mapping 612, which shows a composite of two instances of the first schema 602 may however be different from the corresponding mapping 608. In particular, although product-1 and product-2 may be a single product_type-1, product-1 may have a single variant-1 and product-2 may have a single variant-2. Furthermore, product-3 of product_type-2 may also have a single variant-3. Each of the mappings 610 and 612 may then be used for adding additional schemas.

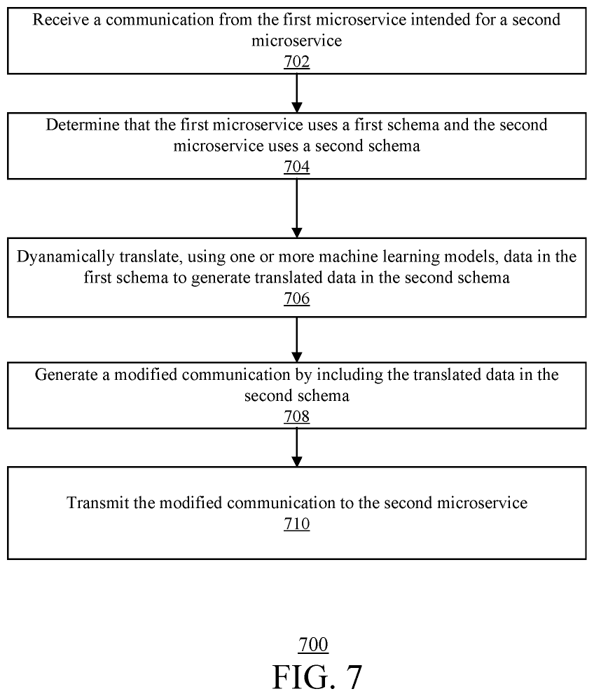

FIG. 7 shows a flow diagram of an example method 700 of translating schemas between different microservices, based on the principles disclosed herein. It should be understood that method 700 shown in FIG. 7 and described herein is just an example, and methods with additional, alternative, and fewer number of steps should be considered within the scope of this disclosure. The steps of the method 700 may be performed by one or more components of the system 100 shown in FIG. 1 and or one or more components of the architecture 200 shown in FIGS. 2-3.

The method begins at step 702, where a communication from the first microservice intended for a second microservice is received. The communication comprises data from the first microservice sent to the second microservice. At step 704, it is determined whether the first microservice uses a first schema and the second microservice uses a second schema. The determination is based on the analysis of the communication packets, e.g., text detection, pixel detection to identify text, etc. At step 706, data in the first schema is dynamically translated using one or more machine learning models to generate data for a second schema. The one or more machine learning models may include, e.g., a naïve Bayes model. At step 708, a modified communication is generated by including the translated data in the second schema. At step 710, the modified communication is transmitted to the second microservice.

Therefore, using the several embodiments disclosed herein, the schemas shown in Table 1 (a first microservice) and Table 2 (a second microservice) may be mapped as shown in Table 3:

TABLE 3
Mapping between the first and second schemas

| | |
|---|---|
| Type | Product without stock levels |
| Name | Identifier |
| Image | Picture |
| SKU | Stock Keeping Unit |
| Category | ProductType |
| Qty on Hand | Available Stock |
| Reorder Point | Minimum Order Quantity |
| Qty on PO | On hand |
| Inventory Asset a/c | Asset a/c |
| Description | Variant Description |
| Sales price | Retail Price |
| Income a/c | Default Sales Account |
| Purchasing Info | Customs Descriptions |
| Cost | Purchase cost |
| Expense a/c | Cost of Goods a/c |
| Preferred Vendor | Supplier Code |
| Taxable | This item is taxable |

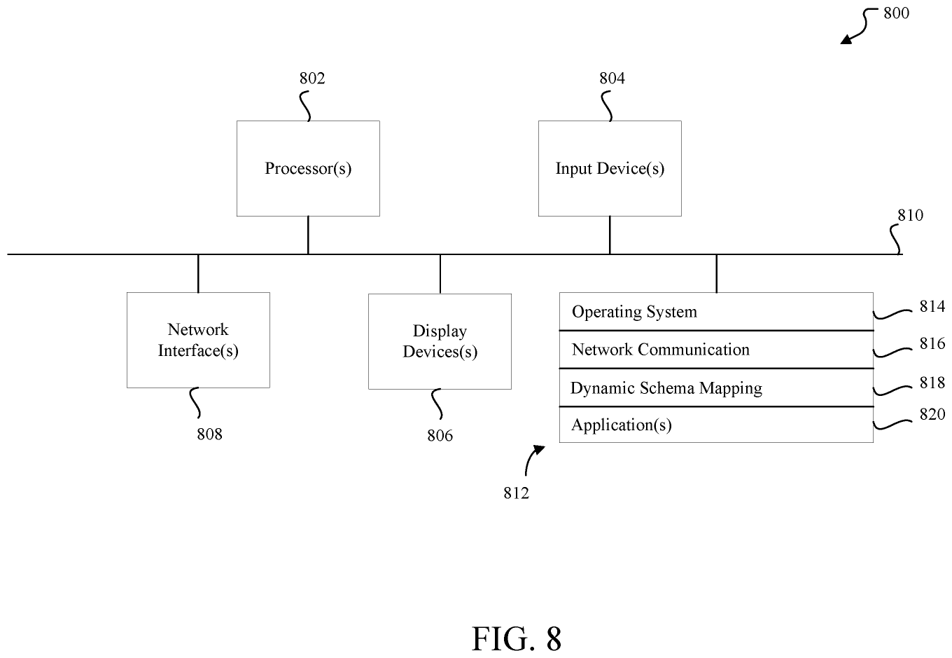

FIG. 8 shows a block diagram of an example computing device 800 that implements various features and processes, based on the principles disclosed herein. For example, computing device 800 may function as first server 120, second server 130, client 150a, client 150b, or a portion or combination thereof in some embodiments. Additionally, the computing device 800 partially or wholly forms the architecture 200 and or wholly or partially hosts the dynamic schema agent 202. The computing device 800 also performs one or more steps of the methods 400 and 700. The computing device 800 is implemented on any electronic device that runs software applications derived from compiled instructions, including without limitation personal computers, servers, smart phones, media players, electronic tablets, game consoles, email devices, etc. In some implementations, the computing device 800 includes one or more processors 802, one or more input devices 804, one or more display devices 806, one or more network interfaces 808, and one or more computer-readable media 812. Each of these components is be coupled by a bus 810.

Display device 806 includes any display technology, including but not limited to display devices using Liquid Crystal Display (LCD) or Light Emitting Diode (LED) technology. Processor(s) 802 uses any processor technology, including but not limited to graphics processors and multi-core processors. Input device 804 includes any known input device technology, including but not limited to a keyboard (including a virtual keyboard), mouse, track ball, and touch-sensitive pad or display. Bus 810 includes any internal or external bus technology, including but not limited to ISA, EISA, PCI, PCI Express, USB, Serial ATA or FireWire. Computer-readable medium 812 includes any non-transitory computer readable medium that provides instructions to processor(s) 802 for execution, including without limitation, non-volatile storage media (e.g., optical disks, magnetic disks, flash drives, etc.), or volatile media (e.g., SDRAM, ROM, etc.).

Computer-readable medium 812 includes various instructions 814 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 804; sending output to display device 806; keeping track of files and directories on computer-readable medium 812; controlling peripheral devices (e.g., disk drives, printers, etc.) which can be controlled directly or through an I/O controller; and managing traffic on bus 810. Network communications instructions 816 establish and maintain network connections (e.g., software for implementing communication protocols, such as TCP/IP, HTTP, Ethernet, telephony, etc.).

Dynamic schema mapping instructions 818 include instructions that implement the disclosed process for a mapping between different schemas, as described throughout this disclosure.

Application(s) 820 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method performed by a processor, said method comprising:
listening, using a shared application fabric plugin, to a plurality of communications between a first microservice and a second microservice;
training, during a runtime, one or more machine learning models using the plurality of communications to generate a schema mapper;
receiving a communication from the first microservice intended for the second microservice, wherein the communication comprises data from the first microservice for the second microservice, the data structured in a first schema having a first set of data fields with corresponding field attributes, the first schema being different from a second schema used by the second microservice;
dynamically translating, using the one or more machine learning models and during the same runtime as training the one or more machine learning models of the schema mapper, the data in the first schema to generate translated data restructured in the second schema having second set of data fields with corresponding field attributes;
generating a modified communication by including the translated data restructured in the second schema; and
transmitting the modified communication to the second microservice.

2. The method of claim 1, wherein using the one or more machine learning models comprises using a naïve Bayes model.

3. The method of claim 1, wherein the one or more machine learning models are associated with a probability distribution tensor.

4. The method of claim 3, wherein the probability distribution tensor comprises probabilities, determined at a plurality of points in a network hosting the first microservice and the second microservice, of corresponding key-value pairs to map one or more fields between the first schema and the second schema.

5-7. (canceled)

8. The method of claim 1, wherein the one or more machine learning models are trained using an unsupervised approach.

9. The method of claim 1, further comprising:
in response to transmitting the modified communication, receiving an error message from the second microservice that the translated data is not compatible with the second microservice; and
in response to receiving the error message, retraining the one or more machine learning models using a supervised approach.

10. (canceled)

11. A system comprising:
at least one processor; and
a computer readable non-transitory storage medium storing computer program instructions that when executed by the at least one processor cause the at least one processor to perform operations comprising:
listening, using a shared application fabric plugin, to a plurality of communications between a first microservice and a second microservice;
training, during a runtime, one or more machine learning models using the plurality of communications to generate a schema mapper;
receiving a communication from the first microservice intended for the second microservice, wherein the communication comprises data from the first microservice to the second microservice, the data structured in a first schema having a first set of data fields with corresponding field attributes, the first schema being different from a second schema used by the second microservice;
dynamically translating, using the one or more machine learning models and during the same runtime as training the one or more machine learning models of the schema mapper, the data in the first schema to generate translated data restructured in the second schema during runtime having second set of data fields with corresponding field attributes;
generating a modified communication by including the translated data restructured in the second schema; and
transmitting the modified communication to the second microservice.

12. The system of claim 11, wherein using the one or more machine learning models comprises using a naïve Bayes model.

13. The system of claim 11, wherein the one or more machine learning models are associated with a probability distribution tensor.

14. The system of claim 13, wherein the probability distribution tensor comprises probabilities, determined at a plurality of points in a network hosting the first microservice and the second microservice, of corresponding key-value pairs to map one or more fields between the first schema and the second schema.

15-17. (canceled)

18. A computer readable non-transitory storage medium storing computer program instructions that when executed cause operations comprising:
listening, using a shared application fabric plugin, to a plurality of communications between a first microservice and a second microservice;
training, during a runtime, one or more machine learning models using the plurality of communications to generate a schema mapper;
receiving a communication from the first microservice intended for the second microservice, wherein the communication comprises data from the first microservice to the second microservice, the data structured in a first schema having a first set of data fields with corresponding field attributes, the first schema being different from a second schema used by the second microservice;
dynamically translating, using the one or more machine learning models and during the same runtime as training the one or more machine learning models of the schema mapper, the data in the first schema to generate translated data restructured in the second schema having second set of data fields with corresponding field attributes;
generating a modified communication by including the translated data restructured in the second schema; and
transmitting the modified communication to the second microservice.

19. The non-transitory storage medium of claim 18, wherein using the one or more machine learning models comprises using a naïve Bayes model.

20. The non-transitory storage medium of claim 18, wherein the one or more machine learning models are associated with a probability distribution tensor.
